(19) United States
(12) Patent Application Publication
(10) Pub. No.: US 2021/0155352 A1
(43) Pub. Date: May 27, 2021

(54) METHOD FOR MANUFACTURING A LEADING EDGE LIMITING AERODYNAMIC DISTURBANCES, A LEADING EDGE OBTAINED FROM THE METHOD AND AERODYNAMIC AIRCRAFT PROFILE COMPRISING SUCH A LEADING EDGE

(71) Applicant: Airbus SAS, BLAGNAC (FR)

(72) Inventor: Mathias FAROUZ-FOUQUET, BLAGNAC (FR)

(21) Appl. No.: 16/953,878

(22) Filed: Nov. 20, 2020

(30) Foreign Application Priority Data
Nov. 25, 2019 (FR) 1913163

(51) Int. Cl. B64F 5/10; B64C 3/28; B21D 53/92

(52) U.S. Cl. CPC B64F 5/10; B21D 53/92; B64C 3/28

(57) ABSTRACT

A method for manufacturing a leading edge comprising a structure and at least one outer wall, the manufacturing method comprising a step of mounting of the structure and an assembly step aiming to link the structure and the outer wall during which the outer wall is held pressed against a conformation surface having a profile identical to a theoretical outer surface configured to limit aerodynamic disturbances. This manufacturing method makes it possible to improve the aerodynamic efficiencies of the leading edge thus obtained and of the aerodynamic aircraft profile incorporating same.

### CROSS-REFERENCES TO RELATED APPLICATIONS

This application claims the benefit of the French patent application No. 1913163 filed on Nov. 25, 2019, the entire disclosures of which are incorporated herein by way of reference.

### FIELD OF THE INVENTION

The present application relates to a method for manufacturing a leading edge limiting aerodynamic disturbances, a leading edge obtained from the method and an aerodynamic aircraft profile comprising at least one such leading edge.

### BACKGROUND OF THE INVENTION

According to a configuration that can be seen in FIG. 1, an aircraft 10 comprises a fuselage 12, a tail unit 13 positioned at the rear end of the fuselage 12 and wings 14, positioned on either side of the fuselage, having a first end 14.1 linked to the fuselage 12 and a second end 14.2 at a distance from the fuselage 12.

Hereinafter in the description, for each wing 14, a longitudinal direction DL is parallel to a direction extending between the first and second ends 14.1, 14.2 of the wing 14. A transverse plane is a plane at right angles to the longitudinal direction DL.

The terms “front” and “rear” refer to the direction of flow of the air around the wing 14 in flight, the air flowing from front to rear.

According to one embodiment, a wing 14 comprises a top surface 16.1, called upper surface, a bottom surface 16.2 called lower surface, the top and bottom surfaces 16.1, 16.2 being linked at the front by a leading edge 18 and at the rear by a trailing edge 20.

As illustrated in FIG. 3, the leading edge 18 comprises an outer wall 22, with a C-shaped cross section, defining an aerodynamic profile and having a lip 22.0 extended by a top part 22.1 which extends to the top surface 16.1, and by a bottom part 22.2 which extends to the bottom surface 16.2.

To maintain a laminar flow for as long as possible from the leading edge 18, on either side of the wing 14, the outer surfaces of the top and bottom parts 22.1, 22.2 of the leading edge 18 must be positioned respectively at the same level as the top and bottom surfaces 16.1, 16.2 of the wing 14.

According to an embodiment that can be seen in FIGS. 4a, 4b, 4c and 5a, and 5b, in addition to the outer wall 22, the leading edge 18 comprises several transverse reinforcers 24 positioned in transverse planes and spaced apart in the longitudinal direction DL. Each traverse reinforcer 24 has a base 24.1 linked to the structure of the wing 14 and a peripheral edge 24.2 having a C-shaped profile, like the outer wall 22.

The leading edge 18 also comprises several longitudinal reinforcers 26, parallel to the longitudinal direction DL, distributed along the peripheral edges 24.2 of the transverse reinforcers 24, to which the outer wall 22 is added and fixed. According to one configuration, each longitudinal reinforcer 26 has an omega-shaped cross section comprising two tabs 26.1, 26.2 positioned on either side of a central part 26.3, the tabs 26.1, 26.2 being linked to the transverse reinforcers 24, the central part 26.3 being linked to the outer wall 22.

According to one procedure, the transverse reinforcers 24 of the leading edge 18 are positioned on a tooling according to a given configuration, then the longitudinal reinforcers 26 are fixed to the transverse reinforcers 24 with fixing elements of rivet type. Finally, the outer wall 22, initially flat, is conformed then linked to the longitudinal reinforcers 26 using fixing elements of rivet type.

According to this embodiment, the outer wall 22 comprises a first edge 28.1 attached to the top surface 16.1 of the wing 14 in operation, and a second edge 28.2 attached to the bottom surface 16.2 of the wing 14 in operation. Next, the leading edge 18 is linked to the structure of the wing 14. Despite the reduced tolerance intervals for the manufacturing of the transverse and longitudinal reinforcers 24, 26 and for the assembly thereof, there remain, at the end of the wing 14 assembly method, offsets E1, E2 which can be significant, between the outer surfaces of the top and bottom parts 22.1, 22.2 of the leading edge 18 and the top and bottom surfaces 16.1, 16.2 of the wing 14, as illustrated in FIGS. 5a, 5b.

These offsets E1, E2 are detrimental to the aerodynamic efficiencies of the wing 14 by disturbing the laminar flow flowing on either side of the wing 14.

The present invention aims to remedy all or some of the drawbacks of the prior art.

### SUMMARY OF THE INVENTION

To this end, the subject of the invention is a method for manufacturing a leading edge comprising a structure and at least one outer wall, the manufacturing method comprising a step of mounting of the structure and an assembly step aiming to link the structure and the outer wall.

According to the invention, during the assembly step, the outer wall is held pressed against a conformation surface having a profile identical to a theoretical outer surface configured to limit aerodynamic disturbances.

When the leading edge thus obtained is positioned at the front of an aerodynamic profile such as an airplane wing, this manufacturing method makes it possible to reduce the differences between the outer surface of the leading edge and the top and bottom surfaces of the aerodynamic profile, thus limiting the aerodynamic disturbances of the flow flowing on either side of the aerodynamic profile.

According to another feature, during the assembly step, the structure and the outer wall are linked by bonding by using a glue having a curing time, the outer wall being held pressed against the conformation surface for the duration of the curing time of the glue.

According to another feature, the glue is configured to compensate for the gap differences between the structure and the outer wall.

According to another feature, the glue is applied to the structure before the structure is offered up to the outer wall.

According to another feature, the structure being positioned on a first tooling according to a first known position, the manufacturing method comprises, prior to the assembly step, a step of positioning of the first tooling supporting the structure with respect to a second tooling comprising the conformation surface against which the outer wall is held pressed according to a second known position.

According to another feature, the second tooling comprises a suction system configured to occupy an active state in which the suction system holds the outer wall pressed and immobile against the conformation surface during the consolidation step and an inactive state in which the suction system does not hold the outer wall pressed and immobile against the conformation surface.

According to another feature, the suction system is in the inactive state as long as the outer wall is not positioned with respect to the second tooling according to the second known position then switched to the active state as soon as the outer wall is positioned with respect to the second tooling according to the second known position, before the assembly step.

According to another feature, the outer wall is formed according to an approximately C-shaped profile before being pressed against the conformation surface.

Another subject of the invention is a leading edge obtained from the manufacturing method according to one of the preceding features and an aerodynamic aircraft profile comprising a top surface, a bottom surface and, at the front, a leading edge obtained from the manufacturing method according to one of the preceding features.

### BRIEF DESCRIPTION OF THE DRAWINGS

Other features and advantages will emerge from the following description of the invention, the description being given purely by way of example, in light of the attached drawings in which:

FIG. 1 is a side view of an aircraft,

FIG. 2 is a perspective view of a wing of an aircraft,

FIG. 3 is a perspective view of a front part of a wing of an aircraft,

FIGS. 4a, 4b and 4c are a schematic representation of the different steps of a method for manufacturing a leading edge illustrating an embodiment of the prior art,

FIGS. 5a and 5b are a cross section of a front part of a wing illustrating an embodiment of the prior art,

FIG. 6 is a side view of a structure of a leading edge positioned on a first tooling illustrating an embodiment of the invention,

FIG. 7 is a schematic representation of a step of insertion of an outer wall of a leading edge into a second tooling illustrating a first embodiment of the invention,

FIG. 8 is a schematic representation of a step of forming of an outer wall of a leading edge in a second tooling illustrating the first embodiment of the invention,

FIG. 9 is a schematic representation of a step of insertion of an outer wall of a leading edge into a second tooling illustrating a second embodiment of the invention,

FIG. 10 is a schematic representation of a step of forming of an outer wall of a leading edge in a second tooling illustrating the second embodiment of the invention,

FIG. 11 is a schematic representation of a step of insertion of the structure of a leading edge into the conformation tooling visible in FIGS. 7 and 8,

FIG. 12 is a schematic representation of a step of adjustment of the positioning of the structure of the leading edge with respect to the outer wall after the insertion step visible in FIG. 11,

FIG. 13 is a schematic representation of a step of assembly of the structure and of the outer wall after the step of adjustment of the positioning visible in FIG. 12, and

FIGS. 14a and 14b are cross sections of a front part of a wing illustrating an embodiment of the invention.

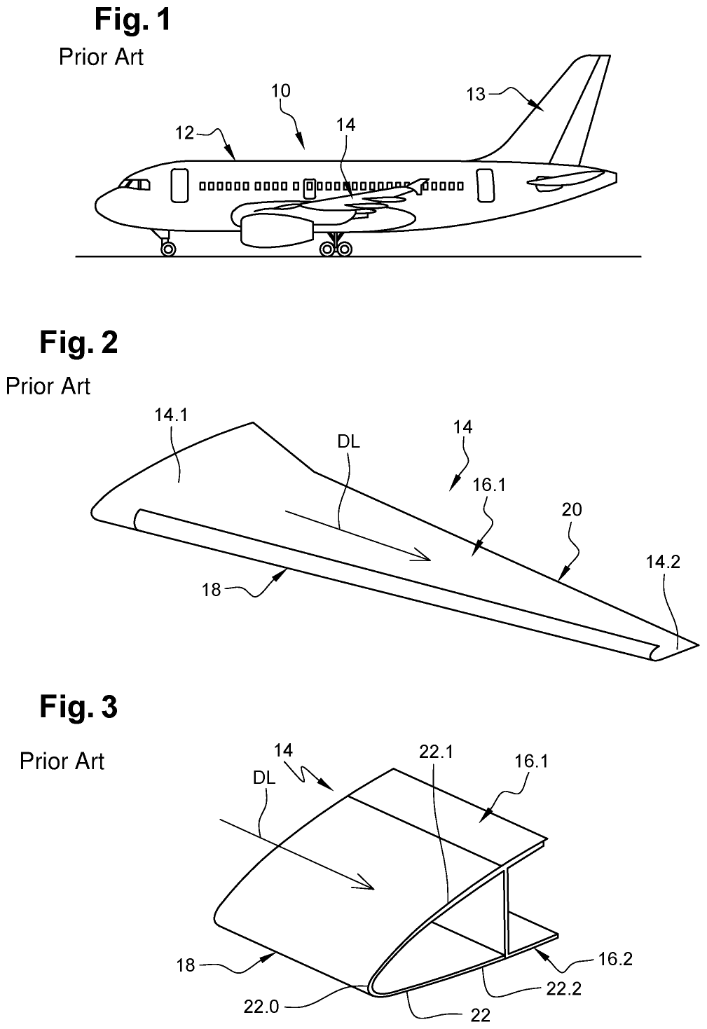

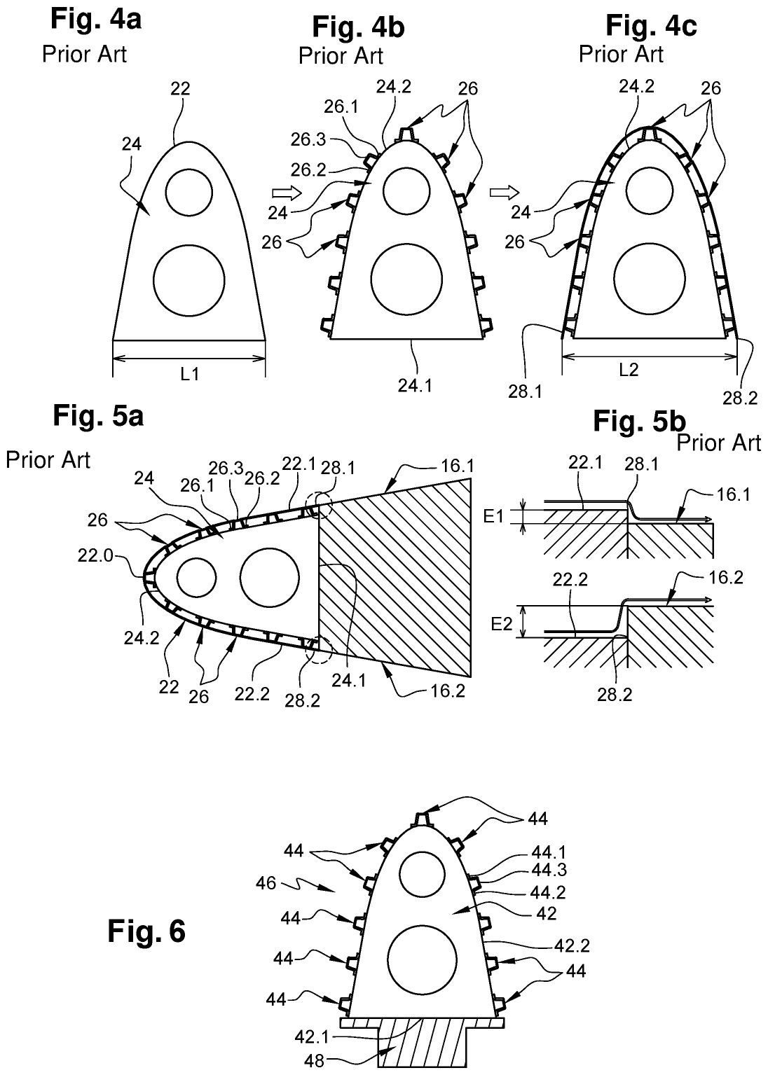

### DETAILED DESCRIPTION OF THE PREFERRED EMBODIMENTS

According to an embodiment visible in FIG. 14a, an airplane wing 30 comprises a top surface 32.1, a bottom surface 32.2, a leading edge 34 at the front and a trailing edge at the rear.

On the structural plane, the airplane wing 30 comprises a wing structure 36 to which the leading edge 34 is fixed.

Although described as applied to an airplane wing, the invention is not limited to that application. Thus, the invention could be applied to the leading edge of a tail unit or of any other aerodynamic profile of an airplane having a structure to which a leading edge 34 is linked.

According to one embodiment, the leading edge 34 comprises several sections joined end-to-end over the entire length of the wing 30.

The leading edge 34 comprises at least one outer wall 38, with a C-shaped cross section, defining an aerodynamic profile and having a lip 38.0 extended by a top part 38.1 which extends to the top surface 32.1 and by a bottom part 38.2 which extends to the bottom surface 32.2.

The outer wall 38 has a first longitudinal edge 40.1 adjacent to the top surface 32.1 in operation and a second longitudinal edge 40.2 adjacent to the bottom surface 32.2 in operation.

According to one embodiment, the leading edge 34 comprises a single outer wall 38. According to another embodiment, the leading edge 34 comprises several juxtaposed outer walls 38.

In theory, the outer wall 38 has a theoretical outer surface F38, limiting aerodynamic disturbances, such that the first longitudinal edge 40.1 has an outer surface at the same level as the top surface 32.1 of the wing 30 and the second longitudinal edge 40.2 has an outer surface at the same level as the bottom surface 32.2 of the wing 30.

The leading edge 34 also comprises several transverse reinforcers 42 positioned in transverse planes and spaced apart in the longitudinal direction DL. As illustrated in FIG. 6, each transverse reinforcer 42 has a base 42.1 linked to the structure 36 of the wing 30 and a peripheral edge 42.2 having a C-shaped profile, like the outer wall 38.

The leading edge 34 also comprises several longitudinal reinforcers 44 approximately parallel to the longitudinal direction DL and distributed along the peripheral edges 42.2 of the transverse reinforcers 42. According to one configuration, each longitudinal reinforcer 44 has an omega-shaped cross section comprising two tabs 44.1, 44.2 positioned on either side of a central part 44.3, the tabs 44.1, 44.2 being linked to the transverse reinforcers 42 by link elements such as rivets for example, the central part 44.3 being separated from the transverse reinforcers 42. Obviously, the invention is not limited to an omega-shaped cross section for the longitudinal reinforcers 44 which can have a Z-shaped, C-shaped, or other cross section.

The transverse and longitudinal reinforcers 42, 44 form a structure 46 of the leading edge 34.

The outer wall 38, the transverse reinforcers 42 and the longitudinal reinforcers 44 can be made of metal or of composite material.

The transverse and longitudinal reinforcers 42, 44 are not detailed further because they can be identical to those of the prior art.

The method for manufacturing the leading edge 34 comprises a step of positioning of the transverse reinforcers 42 on a first tooling 48 and a step of fixing of the longitudinal reinforcers 44 to the transverse reinforcers 42, as illustrated in FIG. 6.

These positioning and fixing steps are not described further because they can be identical to those of the manufacturing method of the prior art.

More generally the method for manufacturing the leading edge comprises a step of mounting of the structure 46 of the leading edge 34. According to one procedure, the structure 46 of the leading edge 34 is positioned on a first tooling 48 according to a first known position.

The method for manufacturing the leading edge 34 comprises a step of conformation of the outer wall 38 by pressing it and holding it pressed against a conformation surface 50 having a profile identical to the theoretical outer surface F38 of the outer wall 38.

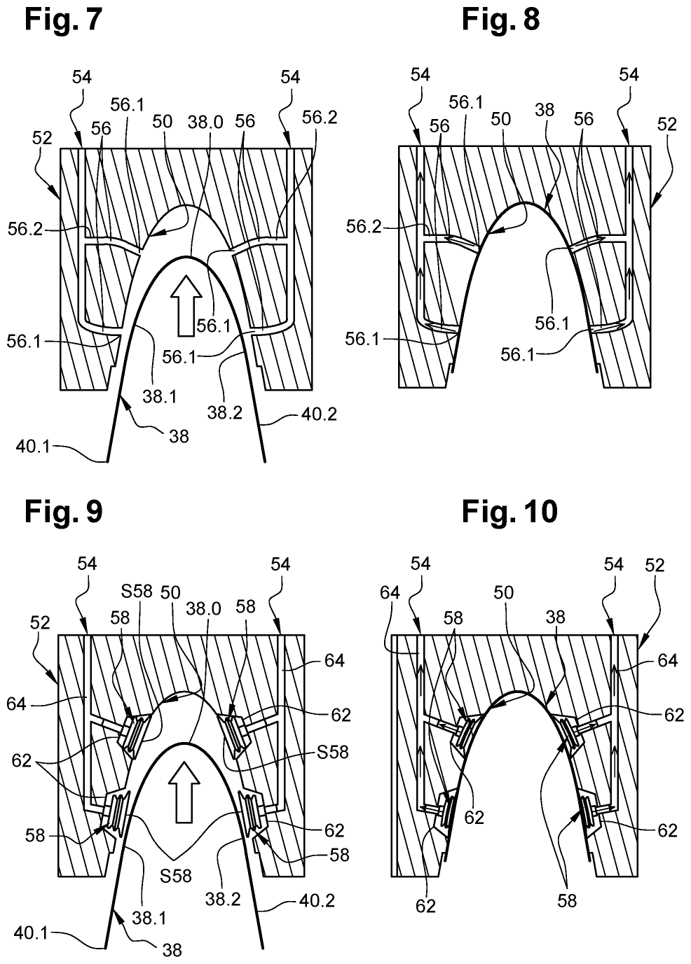

A second tooling 52 is used to perform this conformation step. According to one configuration, this second tooling 52 comprises the conformation surface 50 and a suction system 54 configured to occupy an active state, visible in FIGS. 8 and 10, in which the suction system 54 holds the outer wall 38 pressed and immobile against the conformation surface 50 and an inactive state, visible in FIGS. 7 and 9, in which the suction system 54 no longer holds the outer wall 38 pressed and immobile against the conformation surface 50.

According to a first embodiment visible in FIGS. 7 and 8, the suction system 54 comprises a plurality of channels 56 each having a first end 56.1 emerging at the conformation surface 50 and a second end 56.2 linked to a suction source (not represented).

According to a second embodiment visible in FIGS. 9 and 10, the suction system 54 comprises several suckers 58 positioned in recesses 62 emerging at the conformation surface 50 and linked, via channels 64, to a suction source (not represented). Each sucker 58 has a suction surface S58 configured to be in contact with the outer wall 38 in the active state and positioned on the conformation surface 50.

The number and the positioning of the first ends 56.1 of the channels 56 or of the suckers 58 are determined such that the outer wall 38 closely follows the conformation surface 50 in the active state of the suction system 54.

The second embodiment with the suckers 58 makes it possible to increase the surface area of the outer wall 38 that is in contact with the suction system 54 and thus obtain a better conformation of the outer wall 38 which as closely as possible approximates the theoretical outer surface F38.

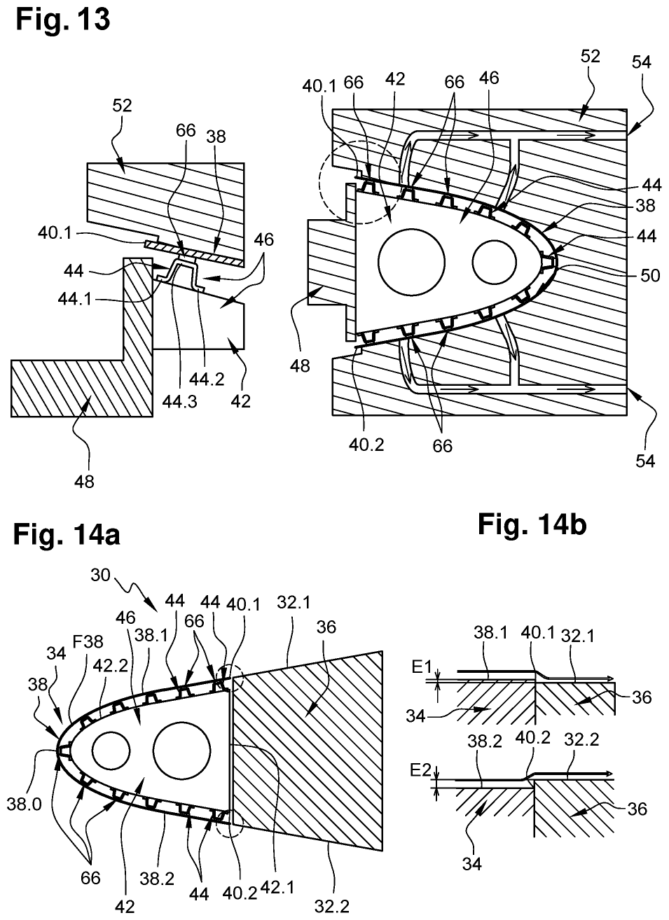

According to one procedure, the step of conformation of the outer wall 38 comprises a first phase of forming of the outer wall 38 according to an approximately C-shaped profile, a second phase of introduction of the outer wall 38 into the second tooling 52 until it comes into contact with the conformation surface 50, as illustrated in FIGS. 7 and 9, and a third phase of activation of the suction system 54 so as to press, and keep pressed, the outer wall 38 against the conformation surface 50, as illustrated in FIGS. 8, 10 to 13.

In the second phase of introduction, the suction system 54 is in the inactive state so it is possible to adjust the positioning of the outer wall 38 with respect to the conformation surface 50. Thus, the suction system 54 remains in the inactive state as long as the outer wall 38 is not positioned correctly with respect to the second tooling 52 according to a second known position. As soon as the outer wall 38 is positioned with respect to the second tooling 52 according to the second known position, the suction system 54 is switched to the active state.

The conformation step is not limited to this embodiment. Other solutions could be envisaged for pressing the outer wall 38, and keeping it pressed, against the conformation surface 50, such as a magnetic system for example.

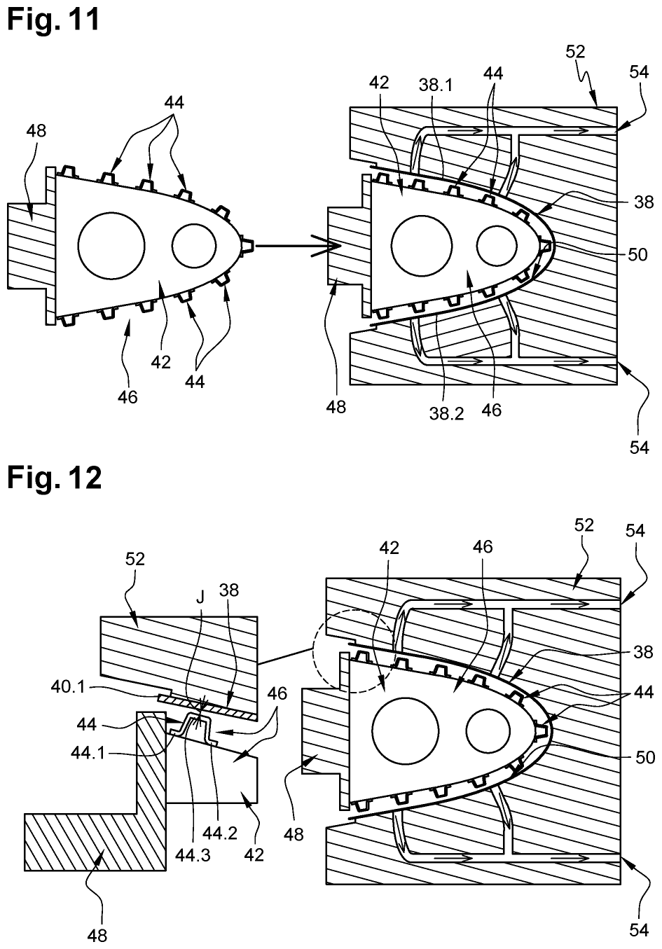

As illustrated in FIGS. 11 to 13, the manufacturing method comprises a step of positioning of the structure 46 of the leading edge 34 with respect to the outer wall 38, the latter being held pressed against the conformation surface 50, then a step of assembly of the structure 46 of the leading edge 34 and of the outer wall 38, the latter being held pressed against the conformation surface 50.

After the assembly step, the suction system 54 is deactivated so that the outer wall 38 is no longer held pressed against the conformation plate 50. Thus, the assembled leading edge 34 is separated from the second tooling 52 and can be extracted therefrom. Finally, the structure 46 of the leading edge 34 is separated from the first tooling 48.

During the step of positioning of the structure 46 of the leading edge 34 with respect to the outer wall 38, the first tooling 48 is moved toward the second tooling 52 so that the structure 46 is positioned between the top and bottom parts 38.1, 38.2 of the outer wall 38, as illustrated in FIG. 11, then the first and second toolings 48 and 52 are positioned with respect to one another. The structure 46 being positioned on the first tooling 48 according to a first known position and the outer wall 38 being positioned on the second tooling 52 according to a second known position, the positioning of the first and second toolings 48, 52 with respect to one another ultimately makes it possible to position the outer wall 38 with respect to the structure 46 of the leading edge 34, as illustrated in FIG. 12.

According to one embodiment, during the assembly step, the structure 46 of the leading edge 34 and the outer wall 38 are linked by bonding by using a glue 66 having a curing time, at the end of which the glue 66 is solidified. According to this embodiment, the outer wall 38 is held pressed against the conformation surface 50 for the duration of the curing time of the glue 66 for as long as the bonding link between the structure 46 of the leading edge 34 and the outer wall 38 is not solid.

According to one configuration, the glue 66 is configured to compensate for any gap differences between the structure 46 of the leading edge 34 and the outer wall 38. The structure 46 and, more particularly, the transverse and/or longitudinal reinforcers 42, 44, are dimensioned so that there remains a gap J (visible in FIG. 12) for the glue 66 between the structure 46 and the outer wall 38.

According to a first procedure, the glue 66 is injected between the structure 46 and the outer wall 38 when the first and second toolings 48, 52 are positioned close to one another.

According to a second embodiment, the glue 66 is applied to the structure 46 and, more particularly, to the central part 44.3 of the longitudinal reinforcers 44, before the structure 46 of the leading edge 34 is offered up to the outer wall 38. According to this second embodiment, the glue 66 is configured so that its curing time allows the structure 46 of the leading edge and the outer wall 38 to be offered up to one another and for them to be positioned with respect to one another.

After its assembly, the leading edge 34 is linked to the structure 36 of the wing 30, by linking the structures 36, 46 of the wing 30 and of the leading edge 34.

The method for manufacturing the leading edge of the invention makes it possible to obtain little or no gaps E1, E2 between the outer surface of the first longitudinal edge 40.1 of the leading edge 34 and the top surface 32.1 of the wing 30 on the one hand, and between the outer surface of the second longitudinal edge 40.2 of the leading edge 34 and the bottom surface 32.2 of the wing 30 on the other hand.

These small gaps E1, E2 make it possible to limit the aerodynamic disturbances and increase the length of the laminar flow flowing from the leading edge 34 on either side of the wing 30.

The manufacturing method of the invention makes it possible to reduce the assembly costs by replacing the fixing elements of rivet type with glue. It also makes it possible to reduce the costs of production of the transverse and longitudinal reinforcers 42, 44 by allowing greater dimensional tolerances.

Finally, the fact that the glue 66 compensates for the differences between the different longitudinal reinforcers 44 and the outer wall 38 makes it possible to reduce the residual stresses in the structure 36 of the leading edge 34 after assembly.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a leading edge comprising a structure and at least one outer wall, the manufacturing method comprising
mounting the structure and
assembling by linking the structure and the outer wall,
during the assembling step, holding the outer wall pressed against a conformation surface having a profile identical to a theoretical outer surface configured to limit aerodynamic disturbances.

2. The manufacturing method as claimed in claim 1, wherein, during the assembling step, the structure and the outer wall are linked by bonding using a glue having a curing time, the outer wall being held pressed against the conformation surface for a duration of the curing time of the glue.

3. The manufacturing method as claimed in claim 2, wherein the glue is configured to compensate for any gap differences between the structure and the outer wall.

4. The manufacturing method as claimed in claim 2, wherein the glue is applied to the structure before the structure is offered up to the outer wall.

5. The manufacturing method as claimed in claim 2, wherein, the structure being positioned on a first tooling according to a first known position, the manufacturing method comprises, prior to the assembling step, a step of positioning of the first tooling supporting the structure with respect to a second tooling comprising the conformation surface against which the outer wall is held pressed according to a second known position.

6. The manufacturing method as claimed in claim 5, wherein the second tooling comprises a suction system configured to occupy an active state in which the suction system keeps the outer wall pressed and immobile against the conformation surface during a consolidation step, and an inactive state in which the suction system does not keep the outer wall pressed and immobile against the conformation surface.

7. The manufacturing method as claimed in claim 6, wherein the suction system is in the inactive state as long as the outer wall is not positioned with respect to the second tooling according to the second known position then switched to the active state as soon as the outer wall is positioned with respect to the second tooling according to the second known position, before the assembling step.

8. The manufacturing method as claimed in claim 1, wherein the outer wall is formed according to an approximately C-shaped profile before being pressed against the conformation surface.

9. A leading edge obtained from the manufacturing method as claimed in claim 1.

10. An aerodynamic aircraft profile comprising a top surface, a bottom surface and, at the front, a leading edge as claimed in claim 9.
